(19) United States
(12) Patent Application Publication
(10) Pub. No.: US 2009/0321587 A1
(43) Pub. Date: Dec. 31, 2009

(54) Double clevis hanger

(76) Inventor: Michael René Thackeray, Alta Loma, CA (US)

Correspondence Address: MICHAEL RENE' THACKERAY, 9450 LA VINE ST., AltALTA LUMA, CA, 91701, US

(21) Appl. No.: 12/228,937

(22) Filed: Aug. 18, 2008

Related U.S. Application Data
(60) Provisional application No. 60/935,567, filed on Aug. 20, 2007.

(51) Int. Cl. F16L 3/11

(52) U.S. Cl. 248/58

(57) ABSTRACT

The double clevis hanger is designed to have two clevis (u-brackets) under one support yoke bracket. The two u-bracket under the one yoke bracket is design with an elevation offset, so that the pipes can cross over one another with the use of the least amount of fittings. On the outside edges of the four corners of the upper yoke bracket, are four tabs turned inward toward one another, so that the two inverted clevis (u-brackets) below the upper support yoke bracket will be seismically secure to the upper yoke. There is a sway bracket attachment that can be attached to the upper yoke that will seismically secure the double hanger to the structure. This double clevis hanger was design to increase the efficiently of the installation of pipe, by eliminating labor and material in the installation of pipe.

### BACKGROUND OF INVENTION

The present invention is directed to clevis hanger which is used throughout the plumbing and the mechanical industry. It is used in the installation of all types pipes for the purpose of supporting pipes from one point to another. The clevis hanger was designed to have only one u-bracket under one support yoke bracket, thus allowing only one pipe to be supported under one yoke bracket and the u-bracket is not seismically secure to yoke.

### SUMMARY OF THE INVENTION

It is the primary objective of the present invention to provide an efficient way to install plumbing system. The double clevis hanger will allow the installation of two pipes under one support yoke with an elevation offset. The ability to hang two pipes under one yoke will increase the labor efficient of pipes installation, and reducing the hanging material such as beam bracket, rod, nuts and washer. Having an elevation offset between the two u-bracket under one yoke will allow pipes connections to be done in an mechanical manner, thus reducing on the amount of fitting used in the plumbing system, and having less fitting in an plumbing system means less restriction in the plumbing system. In many pipe installation, access to connecting support rods are limited, this double clevis hanger will allow half the amount of supports rods needed in limited access areas.

The support yoke has four tabs on the lower corners, these tabs are design to lock in the two u-bracket to the yoke bracket, prevent the two u-bracket from swing outward away from center line of the yoke bracket thus creating a seismically double clevis hanger.

The sway bracket is design to prevent the clevis hanger from swaying during an earthquake, it is attached to the hanger by way of the support rod. The sway bracket can be attached from the hanger to the existing structure seismically in several manner, rod, cable, unistrut.

### BRIEF DESCRIPTION OF THE DRAWING

The invention will be readily understood with reference to the accompanying drawing wherein.

FIG. 1 is an isometric view of double hanger.

FIG. 2 is a front view double hanger.

FIG. 3 is a side view double hanger.

FIG. 4 is an isometric of sway bracket.

FIG. 5 is a front, side, and top view of sway bracket.

FIG. 6 is a front assembly view of hanger and sway bracket.

### DETAILED DESCRIPTION OF THE INVENTION

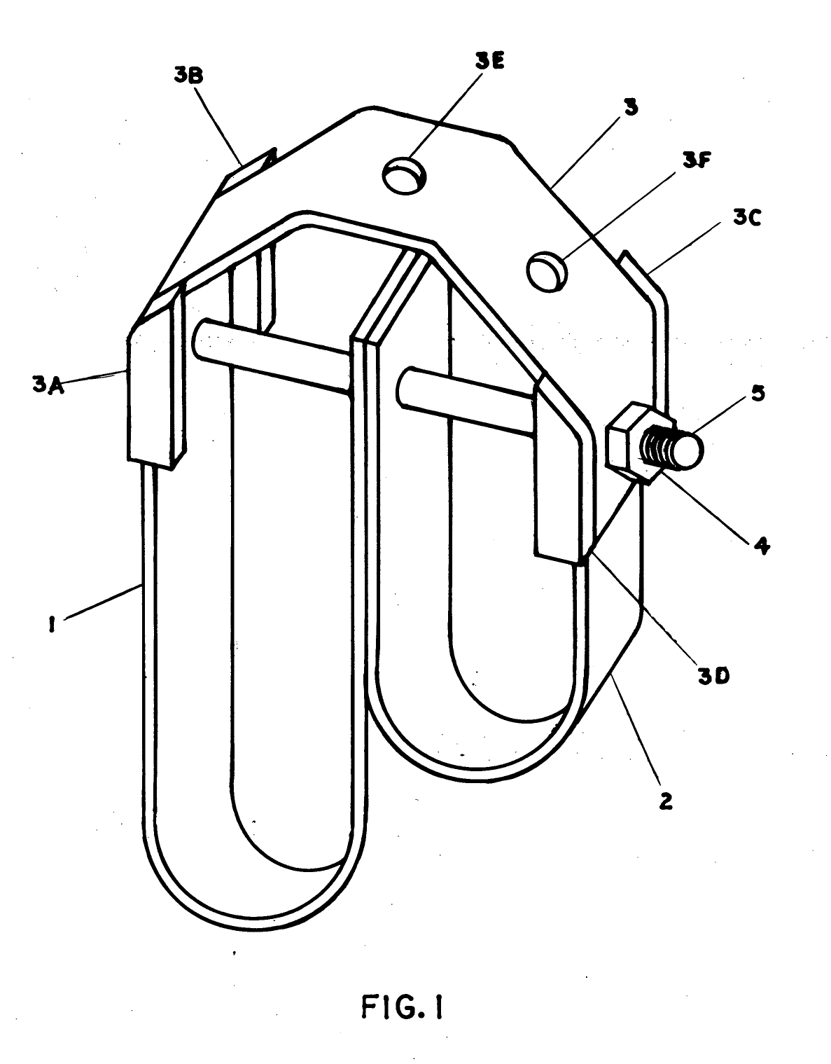

Referring now to the drawings in greater detail, the double clevis hanger FIG. 1 reference 1 is an extended u-bracket, and reference 2 is a shorter u-bracket that are independent from one another. The u-brackets 1 and 2 are then sandwiched between an upper yoke 3. The u-bracket 1 and 2, is secured to the upper yoke 3, by means of a bolt 5 that penetrates through the sides of 3, 1 and 2, and then secured together by means of a nut 4 that is threaded on a bolt 5. On the four lower outside corners of upper yoke 3, are tabs 3A, 3B, 3C, 3D. The tabs are turned inward towards one another to prevent u-brackets 1 and 2 from pivoting in a outward manner away from upper yoke 3. The upper yoke 3 has two holes penetrating through the yoke 3. The hole on FIG. 1 3E is centered on the horizontal part of the upper yoke 3. The second hole on the upper yoke 3, 3F, is located on the inclined part of the yoke 3, that is centered between the vertical part of yoke 3 and the horizontal part of yoke 3.

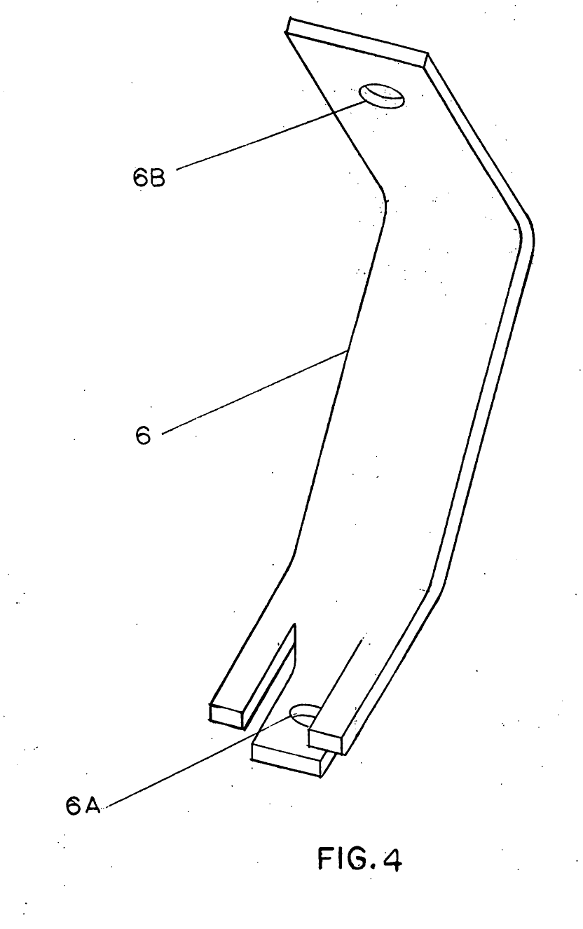

FIG. 4, is a sway bracket intended to be attached to the upper yoke 3, by either bolting through the holes 6A to 3E or bolting through holes 6A to 3F. The bracket 6 has a horizontal part, then a bend to a inclined part, then another bend to a reverse inclined part. The horizontal part of the bracket has two slots running parallel to one another, creating three tabs. The middle tab has been bent on a downward incline to a horizontal bend creating a offset. The offset allows bracket 6 to interlock on to the upper yoke 3.

The double clevis hanger with sway bracket has a total of six separate parts.

One: upper yoke has a vertical part with a predetermined length to a bend, then a upward inclined part with a predetermined length to a bend, then a horizontal part with a predetermined length to a bend, then a downward incline with a predetermined length to a bend, then a vertical part with predetermined length.
Two: extended u-bracket has a vertical part with a predetermined length to a 180 degree bend with a predetermined radius, to a vertical part with a predetermined length.
Three: shorter u-bracket, has a vertical part with a predetermined length to a 180 degree bend with a predetermined radius, to a vertical part with a predetermined length.
Four: bolt, predetermined size
Five: nut, predetermined size
Six: sway bracket, has a horizontal part with a predetermined length to a bend, then an upper incline with a predetermined length to a bend, then to a reverse incline with a predetermined length.

1) As shown on FIG. 1 item 3A, 3B, 3C, and 3D, the tabs on the four lower sides of the of the upper yoke item 3 is to be either welded and or stamped and formed so that they face inward toward one another so that it is contiguous with clevis brackets. The outer side of clevis bracket on FIG. 1 item 1 is to be sandwiched between tabs item 3A and 3B, and the outside of clevis bracket on FIG. 1 item 2 is to be sandwiched between tabs item 3C and 3D.

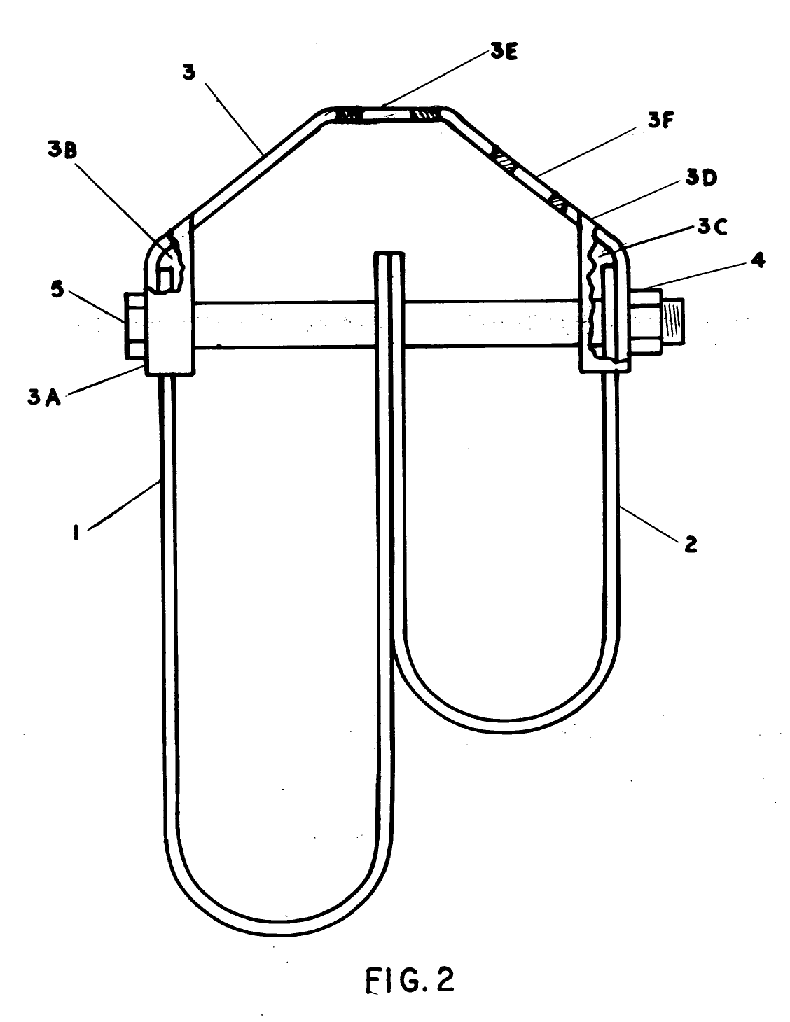

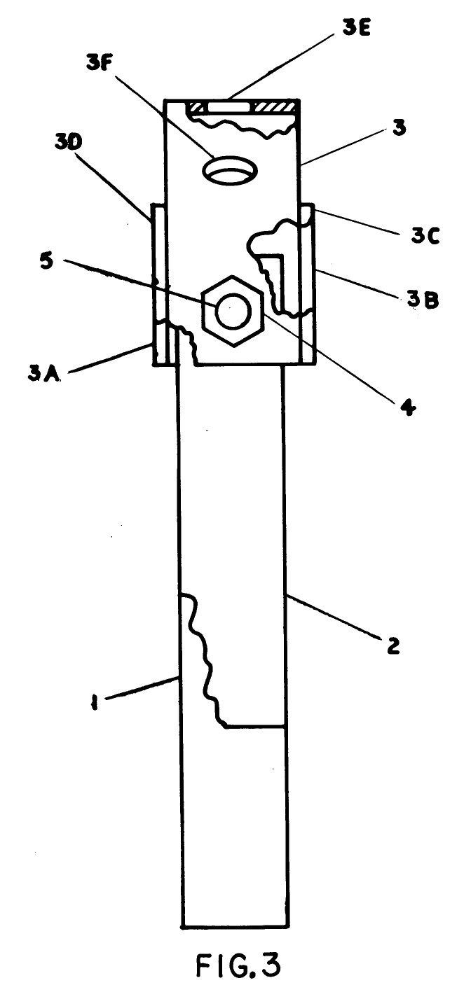

2) As shown on FIG. 1 item 3F, FIG. 3 item 3F, a hole is to be placed on the upper side of yoke on FIG. 1 item 3, FIG. 2 item 3, FIG. 3 item 3, means for sway bracing. A second hole FIG. 3E, FIG. 3 3E is a means to support the hanger.

3) As shown on FIG. 1, item 1 and 2, FIG. 2 item 1 and 2, FIG. 3 item 1 and 2, whereby two clevis (u-bracket) under one upper yoke support bracket.

4) Further including multi clevises (u-brackets) under one upper yoke bracket.

5) As shown on FIG. 1 item 1, FIG. 2 item 1, FIG. 3 item 1, a longer clevis (u-bracket) in relation with the shorter clevis (u-bracket) as shown on FIG. 1 item 2, FIG. 2 item 2, FIG. 3 item 2.

6) Further including multi size circumferences of clevises (u-brackets) under one upper yoke bracket.

7) Further including multi size in length of the longer clevis (u-bracket) FIG. 1 item 1, FIG. 2 item 1, FIG. 3 item 1, in relation to the shorter clevis (u-bracket) FIG. 1 item 2, FIG. 2 item 2 and FIG. 3 item 2, under one upper yoke bracket.

8) As shown on FIG. 1 item 5, FIG. 2 item 5 and FIG. 3 item 5, to secure the clevises (u-brackets) to the upper yoke bracket by means of a bolt thru the left side of the upper yoke bracket FIG. 1 item 3, continuing through the upper left side of clevis brackets FIG. 1 item 1, through right side of clevis bracket FIG. 1 item 1, thru the left side of clevis bracket FIG. 1 item 2, through the right side of clevis bracket FIG. 1 item 2, through the right side upper yoke bracket FIG. 1 item 3, sandwiching the clevises brackets between the upper yoke bracket and secured by a nut shown on FIG. 3 item 4.

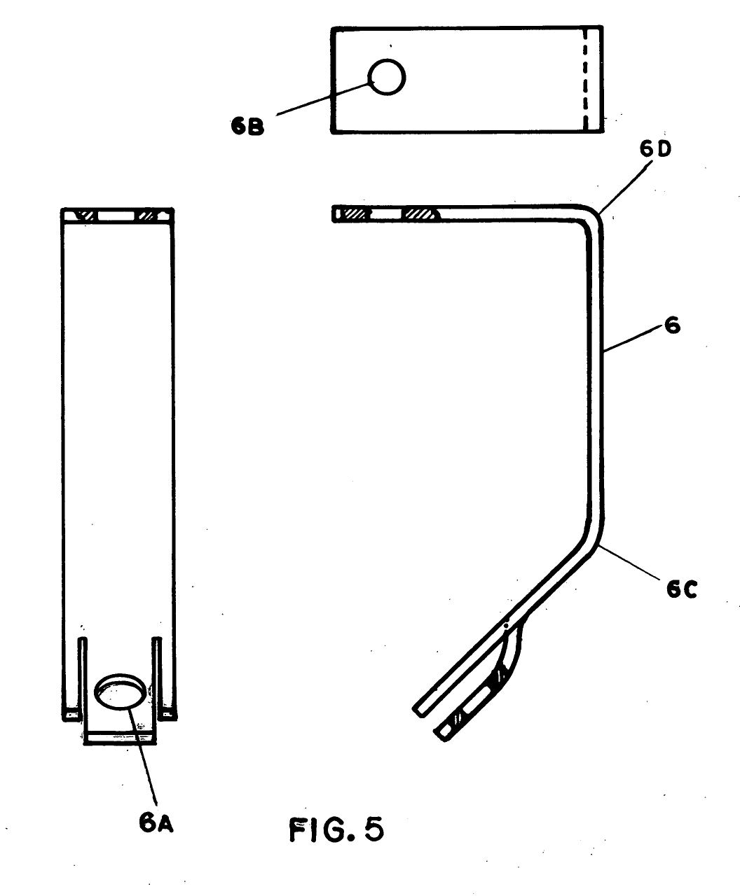

9) As shown on FIG. 5 item 6, one end of sway bracket is to have two slots running perpendicular from end to create three tabs, two outside, and one center tab. The center tab is to have an offset in relation with the two outer tabs as shown on FIG. 7.

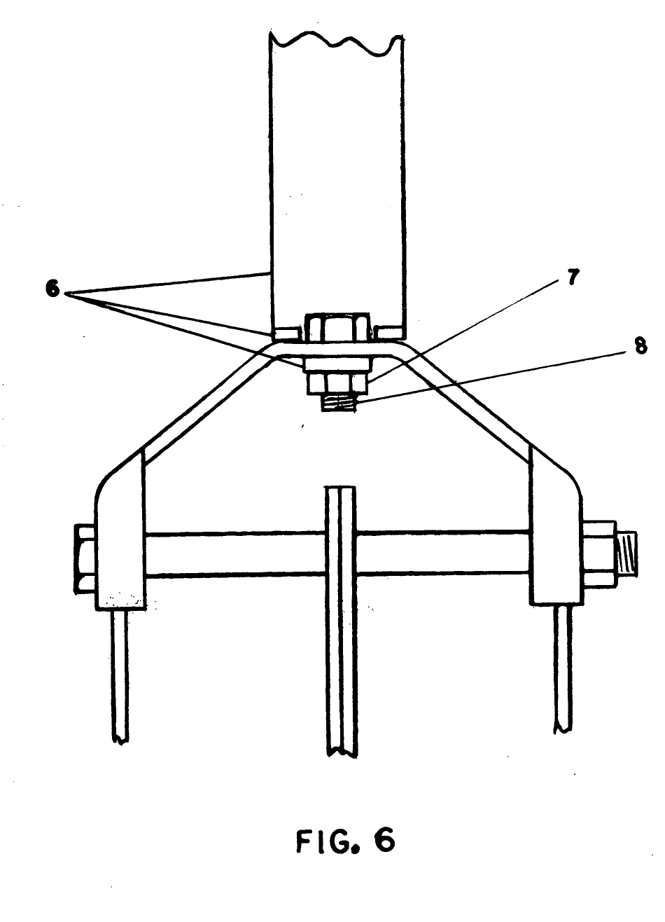

10) Whereby the offset of the center tab in relation to the outer tabs, is to be used as a means for a device to lock on to a clevis hanger as shown on FIG. 6.

11) As shown on FIG. 7 item 6, from bottom end of bracket to a predetermined length an angle is to be bent from horizontal to a predetermined degree FIG. 7 item 6C. From item 6C to a predetermined length 6D. Item 6D is to be bent at a predetermined degree then the bracket is to end at a predetermined length.

12) As shown on FIG. 7 item 6B a means to attach bracket whereby securing the hanger seismically.
